(19) United States
(12) Patent Application Publication
(10) Pub. No.: US 2026/0238424 A1
(43) Pub. Date: Aug. 13, 2026

(54) METHODS AND APPARATUSES FOR PUNCTURED CONTROL RESOURCE SET DETERMINATION

(71) Applicant: LENOVO (BEIJING) LIMITED, Beijing (CN)

(72) Inventors: Yuantao Zhang, Beijing (CN); Zhi Yan, Beijing (CN); Yingying Li, Beijing (CN); Ruixiang Ma, Beijing (CN); Haiming Wang, Beijing (CN)

(21) Appl. No.: 19/156,968

(22) PCT Filed: Feb. 17, 2023
(86) PCT No.: PCT/CN2023/076945

§ 371 Date: Aug. 15, 2025

(51) Int. Cl. H04L 5/00

(52) U.S. Cl. CPC H04L 5/0048

(57) ABSTRACT

Embodiments of the present disclosure relate to methods and apparatuses for punctured control resource set (CORESET) determination. According to some embodiments of the present disclosure, a user equipment (UE) may include: a transceiver; and a processor coupled to the transceiver and configured to: determine a first CORESET; and determine control resource element (CCE) to resource element group (REG) mapping for the first CORESET based on at least one of the followings: a physical resource block (PRB) offset for the first CORESET; a number of punctured PRBs of a punctured synchronization signal block (SSB); or a shift value.

### TECHNICAL FIELD

Embodiments of the present disclosure generally relate to wireless communication technology, and more particularly to methods and apparatuses for determining punctured control resource set (CORESET).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a lower channel bandwidth may be supported. To support the lower channel bandwidth, some resources in a CORESET may be punctured. Details regarding the punctured CORESET need to be studied.

### SUMMARY

Some embodiments of the present disclosure provide a user equipment (UE). The UE may include: a transceiver; and a processor coupled to the transceiver and configured to: determine a first CORESET; and determine control resource element (CCE) to resource element group (REG) mapping for the first CORESET based on at least one of the followings: a physical resource block (PRB) offset for the first CORESET; a number of punctured PRBs of a punctured synchronization signal block (SSB); or a shift value.

In some embodiments of the present disclosure, wherein the processor is further configured to determine a second CORESET by puncturing a set of resources in the first CORESET, and wherein a lowest PRB in a frequency domain of the second CORESET is aligned with a lowest PRB in the frequency domain of a CCE, wherein the index of the CCE is based on the shift value.

In some embodiments of the present disclosure, wherein the first CORESET is configured based on the PRB offset, and wherein: the PRB offset indicates the number of PRBs between a lowest PRB in a frequency domain of the first CORESET and a lowest PRB in the frequency domain of a non-punctured SSB; or the PRB offset indicates the number of PRBs between a lowest PRB in the frequency domain of the first CORESET and a lowest PRB in the frequency domain of the punctured SSB.

In some embodiments of the present disclosure, wherein the CCE is a CCE included in the first CORESET and the shift value is independent of an identity (ID) of a cell on which the UE camps.

In some embodiments of the present disclosure, wherein the shift value is determined such that it enables a best physical downlink control channel (PDCCH) multiplexing capacity for an aggregation level.

In some embodiments of the present disclosure, wherein the CCE is a CCE indexed with 0, 8, or 9 in the first CORESET.

In some embodiments of the present disclosure, wherein the shift value is determined based on an association between an ID of a cell on which the UE camps and a CCE in a set of CCEs.

In some embodiments of the present disclosure, wherein the set of CCEs comprises CCEs that enable substantively the same physical downlink control channel (PDCCH) detection performance.

In some embodiments of the present disclosure, wherein the processor is further configured to: determine a set of CCEs in a second CORESET from the first CORESET based on the mapping; and determine a physical downlink control channel (PDCCH) candidate including one or more CCEs within the set of CCEs based on an aggregation level.

In some embodiments of the present disclosure, wherein the processor is further configured to perform at least one of the following: performing a PDCCH detection in the one or more CCEs of the PDCCH candidate; performing a PDCCH detection in the one or more CCEs of the PDCCH candidate in the case that the number of CCEs included in the PDCCH candidate is equal to a value within a set of values; or determining that the PDCCH candidate is invalid for PDCCH transmission in the case that a number of CCEs in the PDCCH candidate is smaller than a threshold.

In some embodiments of the present disclosure, wherein the set of values includes 4, 8, or both.

Some embodiments of the present disclosure provide a base station (BS). The BS may include: a transceiver; and a processor coupled to the transceiver and configured to: determine a first CORESET; and determine CCE to REG mapping for the first CORESET based on at least one of the followings: a PRB offset for the first CORESET, a number of punctured PRBs of a punctured SSB, or a shift value.

In some embodiments of the present disclosure, wherein the processor is further configured to determine a second CORESET by puncturing a set of resources in the first CORESET, and wherein a lowest PRB in a frequency domain of the second CORESET is aligned with a lowest PRB in the frequency domain of a CCE, wherein the index of the CCE is based on the shift value.

In some embodiments of the present disclosure, wherein the processor is further configured to configure the first CORESET based on the PRB offset, and wherein: the PRB offset indicates the number of PRBs between a lowest PRB in a frequency domain of the first CORESET and a lowest PRB in the frequency domain of a non-punctured SSB; or the PRB offset indicates the number of PRBs between a lowest PRB in the frequency domain of the first CORESET and a lowest PRB in the frequency domain of the punctured SSB.

In some embodiments of the present disclosure, wherein the CCE is a CCE included in the first CORESET and the shift value is independent of an ID of a cell on which a UE camps.

In some embodiments of the present disclosure, wherein the shift value is determined such that it enables a best physical downlink control channel (PDCCH) multiplexing capacity for an aggregation level.

In some embodiments of the present disclosure, wherein the CCE is a CCE indexed with 0, 8, or 9 in the first CORESET.

In some embodiments of the present disclosure, wherein the shift value is determined based on an association between an ID of a cell on which the UE camps and a CCE in a set of CCEs.

In some embodiments of the present disclosure, wherein the set of CCEs comprises CCEs that enable substantively the same physical downlink control channel (PDCCH) detection performance.

In some embodiments of the present disclosure, wherein the processor is further configured to: determine a set of CCEs in a second CORESET from the first CORESET based on the mapping; and determine a physical downlink control channel (PDCCH) candidate including one or more CCEs within the set of CCEs based on an aggregation level.

In some embodiments of the present disclosure, wherein the processor is further configured to perform at least one of the following: transmitting a PDCCH in the one or more CCEs of the PDCCH candidate; transmitting a PDCCH in the one or more CCEs of the PDCCH candidate in the case that the number of CCEs included in the PDCCH candidate is equal to a value within a set of values; or determining that the PDCCH candidate is invalid for PDCCH transmission in the case that a number of CCEs in the PDCCH candidate is smaller than a threshold.

In some embodiments of the present disclosure, wherein the set of values includes 4, 8, or both.

Some embodiments of the present disclosure provide a method performed by a UE. The method may include: determining a first CORESET; and determining CCE to REG mapping for the first CORESET based on at least one of the followings: a PRB offset for the first CORESET; a number of punctured PRBs of a punctured SSB; or a shift value.

Some embodiments of the present disclosure provide a method performed by a BS. The method may include: determining a first CORESET; and determining CCE to REG mapping for the first CORESET based on at least one of the followings: a PRB offset for the first CORESET; a number of punctured PRBs of a punctured SSB; or a shift value.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system according to some embodiments of the present disclosure;

FIG. 2 illustrates an exemplary structure of an SSB according to some embodiments of the present disclosure;

FIGS. 3A and 3B illustrate two exemplary CCE to REG mappings according to some embodiments of the present disclosure;

FIG. 4 is a flow chart illustrating an exemplary method for determining a CORESET according to some embodiments of the present disclosure;

FIGS. 5A and 5B illustrate two exemplary methods for determining CCE to REG mapping according to some embodiments of the present disclosure; and

FIG. 6 illustrates a simplified block diagram of an exemplary apparatus according to some embodiments of the present disclosure.

### DETAILED DESCRIPTION

The detailed description of the appended drawings is intended as a description of preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP LTE and LTE advanced, 3GPP 5G NR, 5G-Advanced, 6G, and so on. It is contemplated that along with developments of network architectures and new service scenarios, all embodiments in the present disclosure are also applicable to similar technical problems; and moreover, the terminologies recited in the present disclosure may change, which should not affect the principle of the present disclosure.

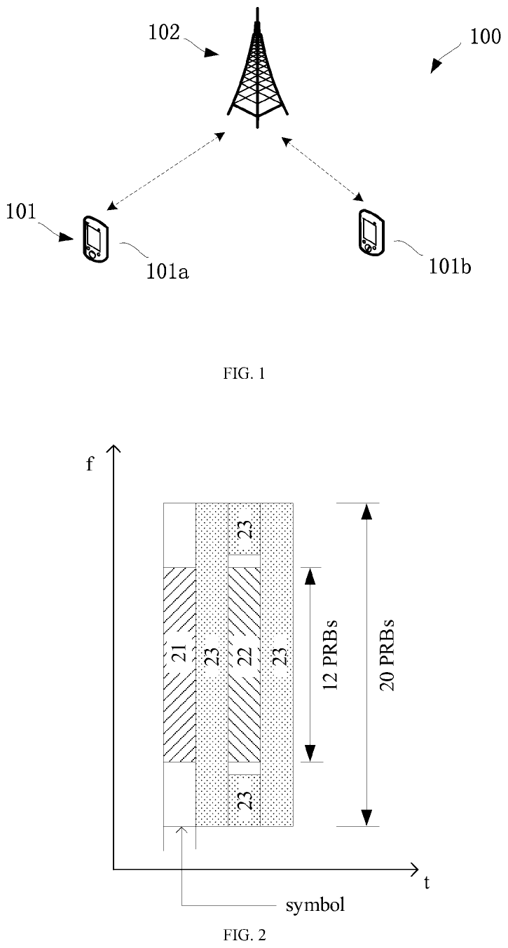

FIG. 1 illustrates an exemplary wireless communication system 100 in accordance with some embodiments of the present disclosure.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 101a and the UE 101b in the embodiments of FIG. 1 are in a coverage area of the BS 102, and may transmit information or data to the BS 102 and receive control information or data from the BS 102, for example, via LTE or NR Uu interface. In other embodiments, one or more of the UE 101a and the UE 101b may be outside of the coverage area of the BS 102. In some embodiments, the UE 101a and the UE 101b may communicate with each other via sidelink.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a generalized Node B (gNB), a Home Node-B, a relay node, or a device, or described using other terminology used in the art. The BS 102 is generally a part of a radio access network that may include one or more controllers communicably coupled to the BS 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein the BS(s) 102 transmit data using an orthogonal frequency division multiplexing (OFDM) modulation scheme on the downlink (DL) and the UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS(s) 102 may communicate using other communication protocols, such as the IEEE 802.11 family of wireless communication protocols. Further, in some embodiments of the present disclosure, the BS(s) 102 may communicate over licensed spectrums, whereas in other embodiments, the BS(s) 102 may communicate over unlicensed spectrums. The present disclosure is not intended to be limited to the implementation of any particular wireless communication system architecture or protocol. In yet some embodiments of the present disclosure, the BS(s) 102 may communicate with the UE(s) 101 using the 3GPP 5G protocols.

A communication system (e.g., NR) can support multiple channel bandwidths due to the flexible numerology implementation. The minimum channel bandwidth (BW) defined in NR Release 15 (Rel-15) is 5 MHz. That is, channel bandwidths narrower than 5 MHz are not supported in NR currently. However, some operational networks, such as electrical power distribution grid networks and rail communication networks, are looking for future development by deploying 5G services, and their operational channel BW is usually lower than 5 MHz. Given this, NR has started the work to support channel BW lower than 5 MHz. For example, one objective is to specify a 3 MHz channel BW in some of NR operating bands (e.g., bands numbered as n100, n8, n26 and n28 in NR). A 3 MHz channel may correspond to 16 or 15 resource blocks (RBs) (e.g., physical RBs (PRBs)). In the context of the present disclosure, “PRB” and “RB” may be used interchangeably.

In the context of the present disclosure, for clarification, it is assumed that 3 MHz channel corresponds to 16 PRBs. Persons skilled in the art can comprehend that the embodiments of the present disclosure can also apply to a 3 MHz channel including 15 PRBs or any other numbers of RBs or PRBs and other channel BWs lower than 5 MHz including any other numbers of RBs or PRBs.

Some channels, signals (e.g., SSB), or CORESET cannot be accommodated by a channel bandwidth less than 5 MHz.

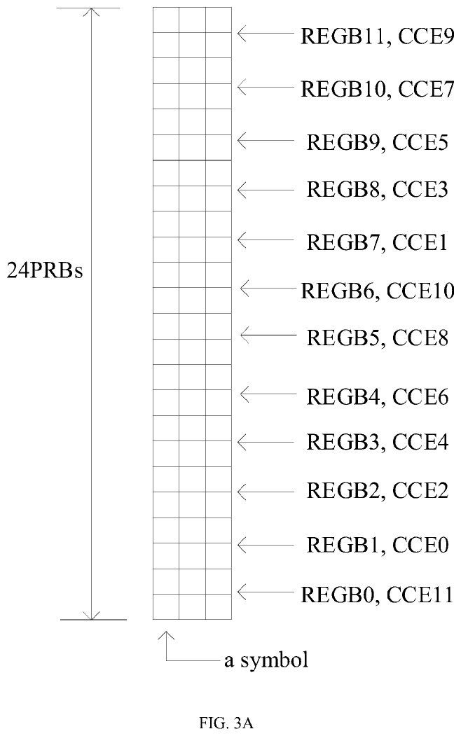

FIG. 2 illustrates an exemplary structure of an SSB according to some embodiments of the present disclosure.

According to FIG. 2, an SSB may include primary synchronization signal (PSS) 21, secondary synchronization signal (SSS) 22, and physical broadcast channel (PBCH) 23. In the time domain, the SSB may include 4 symbols (e.g., 4 orthogonal frequency division multiplexing (OFDM) symbols). In the frequency domain, each of the PSS 21 and the SSS 22 may occupy 12 PRBs (including the guard resource elements (REs)), which corresponds to 2.16 MHz BW with 15 kHz subcarrier spacing (SCS), and the PBCH 23 may occupy 20 PRBs, which corresponds to 3.6 MHz BW with 15 kHz SCS.

Based on the exemplary structure of an SSB in FIG. 2, it can be determined that for a channel with 3 MHz BW, the PSS and SSS may be fully transmitted while the PBCH cannot be fully transmitted. Accordingly, some SSB resources need to be punctured from both transmission and reception point of view such that the SSB may be accommodated by a 3 MHz channel bandwidth.

In addition to SSB, some resources of a CORESET (e.g., CORESET#0) may also need to be punctured. For example, during an initial access of a UE to a cell, after detecting a PBCH, the UE may detect a PDCCH (e.g., carrying downlink control information (DCI)) in CORESET#0, wherein the DCI may schedule a physical downlink shared channel (PDSCH) which includes system information block 1 (SIB1). The configuration for CORESET#0 may be indicated by master information block (MIB) in the PBCH.

The following Table 1 shows an exemplary set of candidate configurations for CORESET#0 for frequency range 1 (FR1) (e.g., 450 MHz-6 GHz).

TABLE 1

| | | Number | Number | |
|---|---|---|---|---|
| | SSB and CORESET | of RBs | of Symbols | Offset |
| Index | multiplexing pattern | N_{RB}^{CORESET} | N_{symb}^{CORESET} | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

Referring to Table 1, each candidate configuration for CORESET#0 may be indicated by an index and include a set of parameters for CORESET#0, including: an SSB and CORESET#0 multiplexing pattern, the number of RBs (e.g., denote as

$${N}_{R B}^{CORESET} )$$

included in CORESET#0, the number of symbols (e.g., denote as

$${N}_{symb}^{CORESET} )$$

included in CORESET#0, and a RB offset (also referred to as PRB offset) between the lowest PRB in the frequency domain of CORESET#0 and a common resource block (CRB) overlapped with the lowest PRB in the frequency domain of an SSB. An MIB may indicate an index from the above table. Based on the index, the UE may determine the corresponding configuration for CORESET#0.

Referring to Table 1, when CORESET#0 is configured with the minimum number of RBs, e.g., 24 RBs, the bandwidth of CORESET#0 is still 4.32 MHz with 15 kHz SCS, which is larger than 3 MHz channel BW. Given this, some resources of CORESET#0 may be punctured.

The PDCCH is transmitted in a CORESET (e.g., CORESET#0) using one or more CCEs. In some examples, each CCE may include 6 REGs, and each REG may include one PRB (e.g., 12 subcarriers) in the frequency domain and one symbol in the time domain. In a CORESET, the REGs are numbered sequentially in the time domain first, and then in the frequency domain. The REGs may be sequentially grouped into REG bundles (REGBs). A UE may assume that the same precoding is used for the REGs in the same REGB, and joint channel estimation may be performed by the UE for the REGs in the same REGB.

For example, REGB i may include REGs {iL, iL+1, . . . , iL+L−1}, where L is the REGB size (e.g., the number of REGs included in an REGB),

$$i = 0 , 1 , … , {N}_{R E G}^{CORESET} / L - 1 , {N}_{R E G}^{CORESET} = {N}_{RB}^{CORESET} {N}_{symb}^{CORESET} and {N}_{R E G}^{CORESET}$$

is the number of REGs in the CORESET,

$${N}_{RB}^{CORESET}$$

is the number of PRBs included in a CORESET,

$${N}_{symb}^{CORESET}$$

is the number of symbols included in a CORESET. The CCE to REG mapping for a CORESET may be either interleaved or non-interleaved and is in units of REG bundles. For example, CCE j may include REG bundles {f(6j/L), f(6j/L+1), . . . , f(6j/L+6/L−1)} where f(⋅) is an interleaver and can be defined as the following formula (1):

$$f ( x ) = ( rC + c + {n}_{shift} ) mod ( {N}_{REG}^{CORESET} / L ) \qquad ( 1 )$$

$$x = cR + r$$

$$r = 0 , 1 , … , R - 1$$

$$c = 0 , 1 , … , C - 1$$

$$C = {N}_{REG}^{CORESET} / ( LR )$$

For CORESET#0, L equals 6, which means that an REGB includes 6 REGs, and thus the size of an REGB is the same as the size of a CCE; R is the interleaver size and equals 2;

$${n}_{shift} = {N}_{ID}^{cell} ,$$

which is an ID of a cell on which the UE camps. For clarification, it is assumed that R equals 2 in the context of the present disclosure. However, persons skilled in the art can comprehend that the embodiments of the present disclosure are also applicable when R equals to any other value.

Based on the above formula and the parameters, it can be determined that the first CCE of CORESET#0, e.g., CCE0, may start from an REGB indexed with X, wherein

$$X = {n}_{shift} mod ( {N}_{R E G}^{CORESET} / L ) .$$

As an example, assuming that the number of REGBs in CORESET#0 is K (e.g., K is always an even number for CORESET#0), the CCE to REG mapping for CORESET#0 may be determined based on the following principle (hereinafter referred to as principle #1):
CCE 2*i (wherein the value “2” corresponds to “R” in the above formula) maps to REGB X+i, where i=0, 1, 2, . . . , K/2−1. If X+i>K−1, the mapping is continued in a wraparound way from REGB0 in CORESET#0;
CCE 2*i+1 (wherein the value “2” corresponds to “R” in the formula) maps to REGB X+i+K/2, where i=0, 1, 2, . . . , K/2−1. If X+i+K/2>K−1, the mapping is continued in a wraparound way from REGB0.

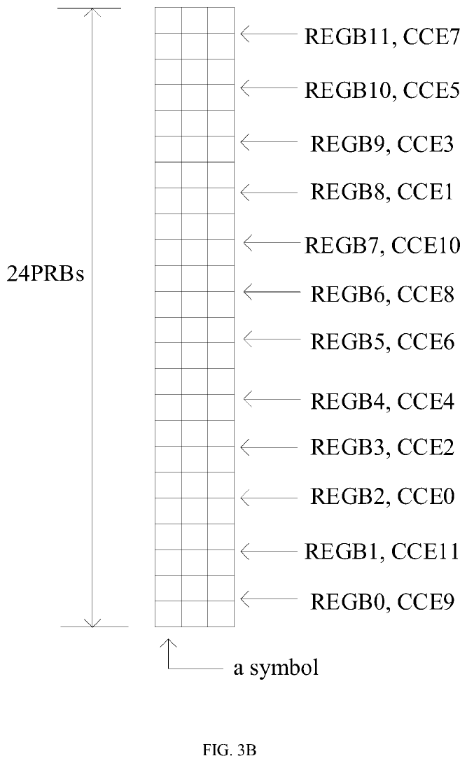

FIGS. 3A and 3B illustrate two exemplary CCE to REG mappings for CORESET#0 according to some embodiments of the present disclosure.

In FIGS. 3A and 3B, CORESET#0 includes 24 PRBs in the frequency domain and 3 symbols in the time domain. Accordingly, CORESET#0 includes 72 PRBs (i.e., 72 REGs) in total. Since one REGB includes 6 REGs, CORESET#0 in FIGS. 3A and 3B may include 12 REGBs, which are indexed with 0-11 (i.e., REGBs 0 to 11) as shown in FIGS. 3A and 3B.

In FIG. 3A, assuming that n_{shift}=1, thus

$$X = {n}_{shift} mod ( {N}_{REG}^{CORESET} / L ) = 1 mod ( 72 / 6 ) = 1.$$

Based on principle #1, the CCE to REG mapping may be as follows: CCEs 0, 2, 4, 6, 8, 10 are mapped to REGBs 1, 2, 3, 4, 5, and 6 respectively; and CCEs 1, 3, 5, 7, 9, 11 are mapped to REGBs 7, 8, 9, 10, 11, and 0, respectively. Such mapping may be represented as (REGB0, CCE11), (REGB1, CCE0), (REGB2, CCE2), (REGB3, CCE4), (REGB4, CCE6), (REGB5, CCE8), (REGB6, CCE10), (REGB7, CCE1), (REGB8, CCE3), (REGB9, CCE5), (REGB10, CCE7), and (REGB11, CCE9) in FIG. 3A.

In FIG. 3B, assuming that n_{shift}=2, thus

$$X = {n}_{shift} mod ( {N}_{REG}^{CORESET} / L ) = 2 mod ( 72 / 6 ) = 2.$$

Based on principle #1, it can be determined that: CCEs 0, 2, 4, 6, 8, 10 are mapped to REGBs 2, 3, 4, 5, 6, and 7 respectively; and CCEs 1, 3, 5, 7, 9, 11 are mapped to REGBs 8, 9, 10, 11, 0, and 1, respectively. Such mapping relationship may be represented as (REGB0, CCE9), (REGB1, CCE11), (REGB2, CCE0), (REGB3, CCE2), (REGB4, CCE4), (REGB5, CCE6), (REGB6, CCE8), (REGB7, CCE10), (REGB8, CCE1), (REGB9, CCE3), (REGB10, CCE5), and (REGB11, CCE7) in FIG. 3B.

CORESET#0 may include one or more PDCCH candidates, wherein each PDCCH candidate includes one or more CCEs on which a PDCCH may be transmitted or detected. The number of CCEs included in a PDCCH candidate may be based on an aggregation level (AL).

The following Table 2 illustrates an exemplary relationship between aggregation levels and the maximum numbers of PDCCH candidates included in CORESET#0.

TABLE 2

| AL | maximum number of PDCCH candidates |
|---|---|
| 4 | 4 |
| 8 | 2 |
| 16 | 1 |

Referring to Table 2, when the aggregation level is 4 (i.e., a PDCCH candidate includes 4 CCEs), the maximum number of PDCCH candidates included in CORESET#0 is 4; when the aggregation level is 8 (i.e., a PDCCH candidate includes 8 CCEs), the maximum number of PDCCH candidates included in CORESET#0 is 2; when the aggregation level is 16 (i.e., a PDCCH candidate includes 16 CCEs), the maximum number of PDCCH candidates included in CORESET#0 is 1.

The CCEs included in a PDCCH candidate with an aggregation level may be determined by a hash function.

As an example, Table 3a shows CCEs included each PDCCH candidate with each aggregation level for CORESET#0 which includes 24 PRBs in the frequency domain and 2 symbols in the time domain. That is, CORESET#0 in Table 3a includes 8 CCEs, e.g., indexed as CCEs 0-7.

TABLE 3a

| | 1^{st} PDCCH | 2^{nd} PDCCH | 3^{rd} PDCCH | 4^{th} PDCCH |
|---|---|---|---|---|
| AL | candidate | candidate | candidate | candidate |
| 4 | CCEs 0, 1, 2, 3 | CCEs 4, 5, 6, 7 | X | X |
| 8 | CCEs 0, 1, 2, 3, | X | X | X |
| | 4, 5, 6, 7 | | | |
| 16 | X | X | X | X |

Referring to Table 3a, when AL=4, CORESET#0 may include two PDCCH candidates, wherein the first PDCCH candidate includes CCEs 0, 1, 2, and 3 and the second PDCCH candidate includes CCEs 4, 5, 6, and 7; and when AL=8, CORESET#0 may include one PDCCH candidate, which includes CCEs 0, 1, 2, 3, 4, 5, 6, and 7.

As another example, Table 3b shows CCEs included each PDCCH candidate with each aggregation level for CORESET#0 which includes 24 PRBs in the time domain and 3 symbols in the time domain. That is, CORESET#0 in Table 3a includes 12 CCEs, e.g., indexed as CCEs 0-11.

TABLE 3b

| | 1^{st} PDCCH | 2^{nd} PDCCH | 3^{rd} PDCCH | 4^{th} PDCCH |
|---|---|---|---|---|
| AL | candidate | candidate | candidate | candidate |
| 4 | CCEs 0, 1, 2, 3 | CCEs 4, 5, 6, 7 | CCEs 8, 9, 10, 11 | X |
| 8 | CCEs 0, 1, 2, 3, | X | X | X |
| | 4, 5, 6, 7 | | | |
| 16 | X | X | X | X |

Referring to Table 3b, when AL=4, CORESET#0 may include three PDCCH candidates, wherein the first PDCCH candidate includes CCEs 0, 1, 2, and 3, the second PDCCH candidate includes CCEs 4, 5, 6, and 7, and the third PDCCH candidate includes CCEs 8, 9, 10, and 11; and when AL=8, CORESET#0 may include one PDCCH candidate, which includes CCEs 0, 1, 2, 3, 4, 5, 6, and 7.

To avoid significant PDCCH detection performance loss in a narrower channel BW (e.g., 3 MHz channel BW), it is desirable to puncture minimum amount of resources in a CORESET (e.g., CORESET#0). In some cases, if the BW of the punctured CORESET#0 can be the same as the channel BW, the performance loss may be the lowest. The punctured CORESET#0 herein may also be referred to as CORESET#0 resources after puncturing. In some cases, if the BW of the punctured SSB can be the same as the channel BW, then CORESET#0 may occupy the whole channel BW. However, if the BW of the punctured SSB is narrower than the channel BW, then the BW of the punctured CORESET#0 may be larger than the BW of the punctured SSB.

In some cases, when using the above CCE to REG mapping method, the number of punctured CCEs for PDCCH candidates may be different for different cells, which may result in different PDCCH detection performances in different cells. This is because the CCE to REG mapping as stated above is dependent on an ID of a cell, e.g., dependent on the parameter n_{shift} (which denotes an ID of a cell on which the UE camps) in formula (1).

For example, assuming that an ID of a cell (denoted as cell #1) on which the UE camps is 2, then n_{shift}=2, and CCE to REG mapping may be shown in FIG. 3B. For a 3 MB channel BW which includes 16 PRBs, 8 PRBs in the frequency domain may be punctured from CORESET#0. For example, REGB0, REGB1, REGB10, and REGB11 of CORESET#0 may be punctured. Accordingly, the punctured CORESET#0 for a cell with ID=2 may include CCEs {0, 2, 4, 6, 8, 10, 1, 3} of the non-punctured CORESET#0. According to Table 3b, the three PDCCH candidates with AL=4 may include CCEs {0, 1, 2, 3}, {4, 6}, {8, 10} respectively after puncturing. That is, two CCEs are punctured from each of the 2^{nd} PDCCH candidate and the 3^{rd} PDCCH candidate.

As another example, assuming that an ID of a cell (e.g., denoted as cell #2) on which the UE camps is 3, then n_{shift}=3, and CCE to REG mapping for CORESET#0 in FIG. 3B may be changed to: CCEs 0, 2, 4, 6, 8, 10 are mapped to REGBs 3, 4, 5, 6, 7, and 8 respectively; CCEs 1, 3, 5, 7, 9, 11 are mapped to REGBs 9, 10, 11, 0, 1, and 2, respectively. For a 3 MB channel BW which includes 16 PRBs, 8 PRBs in the frequency domain may be punctured from CORESET#0. For example, REGB0, REGB1, REGB10, and REGB11 of CORESET#0 may be punctured. Accordingly, the punctured CORESET#0 of a cell with ID=3 may include CCEs {11, 0, 2, 4, 6, 8, 10, 1} of the non-punctured CORESET#0. According to Table 3b, the three PDCCH candidates with AL=4 may include CCEs {0, 1, 2}, {4, 6}, {8, 10, 11} respectively after puncturing. That is, one CCE, two CCEs, and one CCE are punctured from 1^{st} PDCCH candidate, 2^{nd} PDCCH candidate, and 3^{rd} PDCCH candidate, respectively.

Therefore, the PDCCH detection performance in cell #1 may be better than that in cell #2 because one PDCCH candidate with AL=4 in cell #1 includes all CCEs before puncturing (e.g., 4 CCEs for AL=4) while at least one CCE are punctured from each PDCCH candidate in cell #2. This uneven PDCCH detection performance among different cells, simply due to different cell IDs, is not expected from a system point of view. How to solve the uneven PDCCH detection performance among different cells needs to be addressed.

In addition, it is desired that PDCCH detection performance of the punctured CORESET#0 can be as close as possible to that of non-punctured CORESET#0. It is also desired that the punctured CORESET#0 can provide good PDCCH multiplexing capability. How to realize the above design targets also needs to be addressed.

Although the above technical problems are illustrated by taking CORESET#0 as an example, it is contemplated that the similar technical problems may also exist in other CORESETs, and the solutions provided in the embodiments of the present disclosure may also apply to the other CORESETs.

Embodiments of the present disclosure provide solutions for punctured CORESET. For example, embodiments of the present disclosure may propose solutions for CCE to REG mapping for non-punctured CORESET (also can be seen as CCE to REG mapping for punctured CORESET), so as to realize substantively the same PDCCH detection for a punctured CORESET performance among cells, enable the PDCCH detection performance of a punctured CORESET as close as possible to that of the non-punctured CORESET, and provide good PDCCH multiplexing capability for punctured CORESET. More details on embodiments of the present disclosure will be described in the following text in combination with the appended drawings.

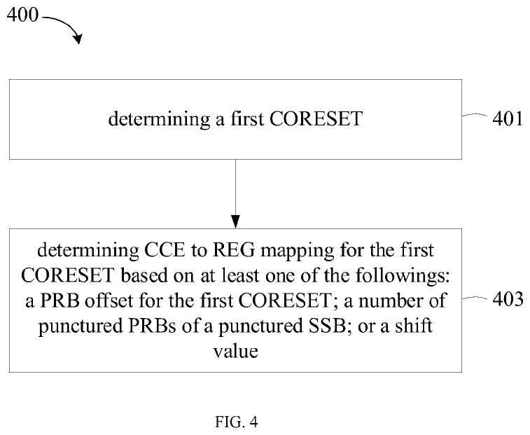

FIG. 4 is a flow chart illustrating an exemplary method 400 for determining a punctured CORESET according to some embodiments of the present disclosure. In some embodiments of the present disclosure, the method in FIG. 4 may be implemented by a UE (e.g., UE 101 as shown in FIG. 1).

In the exemplary method shown in FIG. 4, in step 401, a UE may determine a first CORESET. The first CORESET may be a non-punctured CORESET. In some examples, the first CORESET may be CORESET#0. In some other examples, the first CORESET may be any other CORESET. For example, the UE may determine the location of the first CORESET, the BW of the first CORESET, the number of symbols included in the first CORESET based on an MIB in a PBCH, e.g., based on an index indicated by the MIB as shown in Table 1.

In some embodiments, the UE may determine available resources of the first CORESET in the channel, which are denoted as a second CORESET. The second CORESET is determined by puncturing a set of resources in the first CORESET. Herein, the second CORESET refers to the punctured CORESET, or available resources of the first CORESET after puncturing.

For example, the first CORESET may be CORESET#0 in FIG. 3A or FIG. 3B, and for a 3 MHz channel BW including 16 PRBs, 8 PRBs of CORESET#0 may be punctured. For example, REGBs 0, 1, 10, and 11 may be punctured. In such example, the second CORESET may be the punctured CORESET#0 which includes REGBs 2-9 from non-punctured CORESET#0.

In step 403, the UE may determine CCE to REG mapping for the first CORESET based on at least one of the followings: a PRB offset for the first CORESET; a number of punctured PRBs of a punctured SSB; or a shift value. Determining CCE to REG mapping for the first CORESET may also be seen as determining the CCE to REG mapping for the second CORESET.

In some examples, the first CORESET may be configured based on the PRB offset. As an example, the location and the BW of the first CORESET may be determined based on a non-punctured SSB, and the PRB offset may indicate the number of PRBs between a lowest PRB in a frequency domain of the first CORESET and a lowest PRB in the frequency domain of a non-punctured SSB. As another example, the location and the BW of the first CORESET may be determined based on a punctured SSB, and the PRB offset may indicate the number of PRBs between a lowest PRB in the frequency domain of the first CORESET and a lowest PRB in the frequency domain of the punctured SSB. The PRB offset may be configured, pre-configured or pre-defined. In some examples, the PRB offset may be indicated by the BS to the UE. In some other examples, the PRB offset may not be indicated to the UE by the BS, but is predefined, e.g., to be zero.

The following embodiments provide two solutions for determine CCE to REG mapping for the first CORESET (or for the second CORESET).

### Solution 1

In solution 1, the CCE to REG mapping for the first CORESET is not related to (or independent of) a cell ID, but is common to all cells associated with the first CORESET. As a result, for each cell, the second CORESET includes the same set of CCEs from the first CORESET. Consequently, a PDCCH candidate of an aggregation level of the second CORESET includes the same number of CCEs for all cells, which ensures the same PDCCH detection performance among cells.

In some examples of solution 1, the definition of n_{shift} in formula (1) may be changed. For example, n_{shift} may be determined based on a PRB offset for the first CORESET; a number of punctured PRBs of a punctured SSB; or a shift value After determining the n_{shift}, the UE may determine CCE to REG mapping for the first CORESET based on formula (1) or based on principle #1.

### Embodiment 1

In embodiment 1, the CCE to REG mapping for the first CORESET may be determined based on at least one of PRB offset for the first CORESET or a number of punctured PRBs of a punctured SSB.

As an embodiment, the location and the BW of the first CORESET may be determined based on a non-punctured SSB. In such embodiment, the CCE to REG mapping for the first CORESET may be determined based on the PRB offset for the first CORESET and a number of punctured PRBs of a punctured SSB. The PRB offset may indicate the number of PRBs between a lowest PRB in a frequency domain of the first CORESET and a lowest PRB in the frequency domain of a non-punctured SSB. The number of punctured PRBs of a punctured SSB may be a number of punctured PRBs in the lower edge of the frequency domain of the punctured SSB or in the higher edge of the frequency domain of the punctured SSB.

For example, the UE may determine n_{shift} in formula (1) according to

$$( PRB offset + number of punctured PRBs of a punctured SSB ) * {N}_{symb}^{CORESET} / L ,$$

wherein

$${N}_{symb}^{CORESET}$$

e.g., is the number of REGs included in an REGB. After determining n_{shift}, the UE may determine the CCE to REG mapping for the first CORESET based on formula (1) or principle #1.

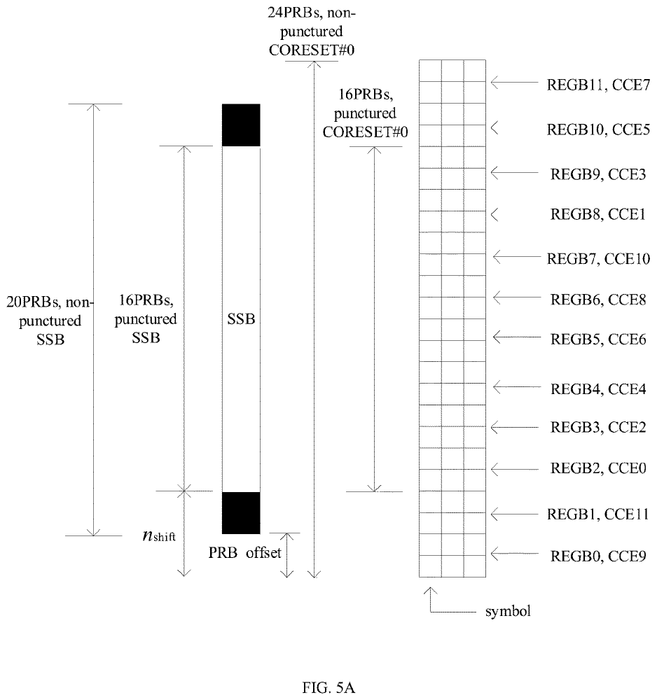

FIG. 5A illustrates an exemplary method for determining CCE to REG mapping according to some embodiments of the present disclosure.

In FIG. 5A, the first CORESET may be CORESET#0 which includes 24 PRBs in the frequency domain and 3 symbols in the time domain. Accordingly, CORESET#0 includes 72 PRBs (i.e., 72 REGs) in total. Since one REGB includes 6 REGs, CORESET#0 in FIG. 5A may include 12 REGBs, which are indexed with 0-11 (i.e., REGBs 0 to 11) as shown in FIG. 5A. Since the channel BW only includes 16 RBs, 8 PRBs (i.e., 8 REGs) of each symbol may be punctured from CORESET#0. For example, REGs 0, 1, 10, and 11 may be punctured from CORESET#0, and thus the second CORESET may be the punctured CORESET#0 including REGs 2-9.

In FIG. 5A, the location and the BW of the first CORESET may be determined based on a non-punctured SSB. For example, the PRB offset in FIG. 5A is 2. In addition, the non-punctured SSB includes 20 PRBs while the channel BW only includes 16 RBs. Then, 2 PRBs in the lower edge of the frequency domain of the non-punctured SSB and 2 PRBs in the higher edge of the frequency domain of the non-punctured SSB are punctured, such that the punctured SSB includes 16 PRBs.

The UE may determine n_{shift} in formula (1) according to

$$( PRB offset + number of punctured PRBs of a punctured SSB ) * {N}_{symb}^{CORESET} / L = ( 2 + 2 ) * 3 / 6 = 2.$$

Based on formula (1) or principle #1, the UE may determine CCE to REG mapping for CORESET#0 as follows: CCEs 0, 2, 4, 6, 8, 10 are mapped to REGBs 2, 3, 4, 5, 6, and 7 respectively; and CCEs 1, 3, 5, 7, 9, 11 are mapped to REGBs 8, 9, 10, 11, 0, and 1, respectively. Such mapping may be represented as (REGB0, CCE9), (REGB1, CCE11), (REGB2, CCE0), (REGB3, CCE2), (REGB4, CCE4), (REGB5, CCE6), (REGB6, CCE8), (REGB7, CCE10), (REGB8, CCE1), (REGB9, CCE3), (REGB10, CCE5), and (REGB11, CCE7) in FIG. 5A.

As another embodiment, the location and the BW of the first CORESET may be determined based on a punctured SSB. In such embodiment, the CCE to REG mapping for the first CORESET may be determined based on the PRB offset for the first CORESET. The PRB offset may indicate the number of PRBs between a lowest PRB in the frequency domain of the first CORESET and a lowest PRB in the frequency domain of the punctured SSB.

For example, the UE may determine n_{shift} in formula (1) according to the

$$PRB offset * {N}_{symb}^{CORESET} / L ,$$

wherein

$${N}_{symb}^{CORESET}$$

is the number of symbols in the first CORESET and L is the REGB size, e.g., the number of REGs included in an REGB. After determining n_{shift}, the UE may determine the CCE to REG mapping for the first CORESET based on formula (1) or principle #1.

FIG. 5B illustrates an exemplary method for determining CCE to REG mapping according to some embodiments of the present disclosure.

In FIG. 5B, the first CORESET may be CORESET#0 which includes 24 PRBs in the frequency domain and 3 symbols in the time domain. Accordingly, CORESET#0 includes 72 PRBs (i.e., 72 REGs) in total. Since one REGB includes 6 REGs, CORESET#0 in FIG. 5B may include 12 REGBs, which are indexed with 0-11 (i.e., REGBs 0 to 11) as shown in FIG. 5B.

In FIG. 5B, the location and the BW of the first CORESET may be determined based on a punctured SSB. For example, the PRB offset in FIG. 5B is 4.

The UE may determine n_{shift} in formula (1) according to:

$$PRB offset * {N}_{symb}^{CORESET} / L = 4 * 3 / 6 = 2.$$

Based on formula 1 or principle #1, the UE may determine CCE to REG mapping for CORESET#0 as follows: CCEs 0, 2, 4, 6, 8, 10 are mapped to REGBs 2, 3, 4, 5, 6, and 7 respectively; and CCEs 1, 3, 5, 7, 9, 11 are mapped to REGBs 8, 9, 10, 11, 0, and 1, respectively. The CCE to REG mapping for CORESET#0 in FIG. 5B is the same as that in FIG. 5A due to the same n_{shift}.

### Embodiment 2

In embodiment 2, in addition to at least one of PRB offset for the first CORESET and a number of punctured PRBs of a punctured SSB, the CCE to REG mapping for the first CORESET may be determined further based on a shift value.

In some examples of embodiment 2, the CCE to REG mapping for the first CORESET may follow a principle (e.g., denoted as principle #2), i.e., the CCE to REG mapping for the first CORESET may be determined such that a lowest PRB (REG) in a frequency domain of the second CORESET is aligned with a lowest PRB in the frequency domain of a CCE. For illustrative purposes, the CCE may be defined as CCE #k (also referred to as CCE k), wherein “k” is the index of the CCE. CCE #k may be a CCE included in the first CORESET and is independent of an ID of a cell on which the UE camps. Such kind of PRB alignment can ensure a whole CCE (instead of a part of resources in a CCE) to be included in the second CORESET (e.g., punctured CORESET), which is beneficial from a channel estimation point of view since channel estimation is performed in units of CCE.

The index of the CCE (i.e., k) may be based on the shift value. For example, the index of the CCE (i.e., k) may be equal to the shift value. The shift value (e.g., k) is common for all cells associated with the first CORESET. For example, the shift value (e.g., k) may be configured, pre-configured, or pre-defined for the UE.

In the embodiments of the present disclosure, for clarification, it is assumed that the index of the CCE is equal to the shift value or vice versa. Persons skilled in the art can comprehend that the index of the CCE may not necessarily be equal to the shift value, but based on the shift value (e.g., there may be a mapping relationship between the index of the CCE (e.g., k) and the shift value) such that the value of k can be determined based on the shift value and satisfy the principles in the present disclosure. In some examples, the shift value (e.g., k) may be equal to 0. For example, the UE may determine that a lowest PRB (or REG) in a frequency domain of the second CORESET is aligned with a lowest PRB in the frequency domain of CCE #0.

As an example, the location and the BW of the first CORESET is determined based on a non-punctured SSB, and the UE may determine n_{shift} in formula (1) according to

$$( PRB offset + number of punctured PRBs of a punctured SSB ) * {N}_{symb}^{CORESET} / L + k .$$

As another example, the location and the BW of the first CORESET is determined based on a punctured SSB, and the UE may determine n_{shift} in formula (1) according to

$$PRB offset * {N}_{symb}^{CORESET} / L + k .$$

In the two examples,

$${N}_{symb}^{CORESET}$$

is the number of symbols in the first CORESET, L is the REGB size, e.g., the number of REGs included in an REGB, and k=0. After determining n_{shift}, the UE may determine the CCE to REG mapping for the first CORESET based on formula (1) or principle #1. For example, the CCE to REG mapping for CORESET#0 may be referred to FIG. 5A or FIG. 5B.

In FIGS. 5A and 5B, as stated above, the punctured CORESET#0 may include REGBs 2-9, which are mapped to CCEs {0, 2, 4, 6, 8, 10, 1, 3} of non-punctured CORESET#0. That is, the punctured CORESET#0 may include CCEs {0, 2, 4, 6, 8, 10, 1, 3}. Then, based on Table 3b, for AL=4, the 1^{st}, 2^{nd}, and 3^{rd} PDCCH candidates of the punctured CORESET#0 contains CCEs {0, 1, 2, 3}, {4, 6}, and {8, 10}, respectively. The above three PDCCH candidates may be seen as a PDCCH candidate with AL=4 and two “equivalent” PDCCH candidates with AL=2. Based on Table 3b, for AL=8, the PDCCH candidate may include CCEs {0, 1, 2, 3, 4, 6}, which can be seen as an “equivalent” PDCCH candidate with AL=6. In some examples, the UE may not perform a PDCCH detection in one or more CCEs of an “equivalent” PDCCH candidate with AL other than AL=4 or AL=8. To guarantee the same PDCCH detection performance with AL=8 in Table 3b, AL=12 may be introduced for non-punctured CORESET#0 (e.g., adding to Table 3b). Then, for the non-punctured CORESET#0, the PDCCH candidate with AL=12 may include CCEs {0, 1, 2, 3, 4, 5, 6, 7, 8, 9, 10, 11}. For the punctured CORESET#0 with 4 CCEs being punctured as shown in FIG. 5A or 5B, the PDCCH candidate with AL=12 may include CCEs {0, 2, 4, 6, 8, 10, 1, 3}, which can be seen as an “equivalent” PDCCH candidate with AL=8.

In some examples, the shift value (e.g., k) may be determined such that it enables a best PDCCH multiplexing capacity for an aggregation level.

For example, the shift value (e.g., k) may be equal to “8.” For example, the UE may determine that a lowest PRB (or REG) in a frequency domain of the second CORESET is aligned with a lowest PRB in the frequency domain of CCE #8.

In some cases, the location and the BW of the first CORESET is determined based on a non-punctured SSB, and the UE may determine n_{shift} in formula (1) according to

$$( PRB offset + number of punctured PRBs of a punctured SSB ) * {N}_{symb}^{CORESET} / L + k .$$

In some cases, the location and the BW of the first CORESET is determined based on a punctured SSB, and the UE may determine n_{shift} in formula (1) according to:

$$PRB offset * {N}_{symb}^{CORESET} / L + k .$$

In the above cases,

$${N}_{symb}^{CORESET}$$

is the number of symbols in the first CORESET, L is the REGB size, e.g., the number of REGs included in an REGB, and k=8. After determining n_{shift}, the UE may determine the CCE to REG mapping for the first CORESET based on formula (1). For example, the CCE to REG mapping for CORESET#0 in FIG. 5A or FIG. 5B may be changed as follows: CCEs 0, 2, 4, 6, 8, 10 are mapped to REGBs 10, 11, 0, 1, 2, and 3 respectively; and CCEs 1, 3, 5, 7, 9, 11 are mapped to REGBs 4, 5, 6, 7, 8, and 9, respectively.

In such example, the punctured CORESET#0 in FIG. 5A or FIG. 5B may include CCEs {8, 10, 1, 3, 5, 7, 9, 11}. Then, based on Table 3b, for AL=4, the 1st, 2nd, and 3rd PDCCH candidates of the punctured CORESET#0 contains CCEs {1, 3}, {5, 7}, and {8, 9, 10, 11}, respectively. For AL=8, the PDCCH candidate may include CCEs {1, 3, 5, 7}, which can be seen an “equivalent” PDCCH candidate with AL=4. Therefore, there are two PDCCH candidates with AL=4 in the punctured CORESET#0.

In some cases, to guarantee the same PDCCH detection performance with AL=8 in Table 3b, AL=12 may be introduced for non-punctured CORESET#0 (e.g., adding to Table 3b). Then, for the punctured CORESET#0 with 4 CCEs being punctured in such example, the PDCCH candidate with AL=12 may include CCEs {8, 10, 1, 3, 5, 7, 9, 11}, which can be seen as an “equivalent” PDCCH candidate with AL=8.

As another example, the shift value (e.g., k) may be equal to 9. For example, the UE may determine that a lowest PRB (or REG) in a frequency domain of the second CORESET is aligned with a lowest PRB in the frequency domain of CCE #9.

In some cases, the location and the BW of the first CORESET is determined based on a non-punctured SSB, and the UE may determine n_{shift} in formula (1) according to: floor

$$( ( ( PRB offset + number of punctured PRBs of a punctured SSB ) * {N}_{symb}^{CORESET} / L + k ) / 2 ) - 1 ..$$

In some other cases, the location and the BW of the first CORESET is determined based on a punctured SSB, and the UE may determine n_{shift} in formula (1) according to: floor

$$( ( PRB offset * {N}_{symb}^{CORESET} / L + k ) / 2 ) - 1.$$

In the above cases,

$${N}_{symb}^{CORESET}$$

is the number of symbols in the first CORESET, L is the REGB size, e.g., the number of REGs included in an REGB, and k=9. After determining shift, the UE may determine the CCE to REG mapping for the first CORESET based on formula (1). For example, the CCE to REG mapping for CORESET#0 in FIG. 5A or FIG. 5B may be changed as follows: CCEs 0, 2, 4, 6, 8, 10 are mapped to REGBs 4, 5, 6, 7, 8, and 9, respectively; and CCEs 1, 3, 5, 7, 9, 11 are mapped to REGBs 10, 11, 0, 1, 2, and 3, respectively.

In such example, the punctured CORESET#0 in FIG. 5A or FIG. 5B may include CCEs {9, 11, 0, 2, 4, 6, 8, 10}. Then, based on Table 3b, for AL=4, the 1^{st}, 2^{nd}, and 3^{rd} PDCCH candidates of the punctured CORESET#0 contains CCEs {0, 2}, {4, 6}, and {8, 9, 10, 11}, respectively. For AL=8, the PDCCH candidate may include CCEs {0, 2, 4, 6}, which can be seen an “equivalent” PDCCH candidate with AL=4. Therefore, there are two PDCCH candidates with AL=4 in the punctured CORESET#0.

In some cases, to guarantee the same PDCCH detection performance with AL=8 in Table 3b, AL=12 may be introduced for non-punctured CORESET#0 (e.g., adding to Table 3b). Then, for the punctured CORESET#0 with 4 CCEs being punctured in such example, the PDCCH candidate with AL=12 may include CCEs {9, 11, 0, 2, 4, 6, 8, 10}, which can be seen as an “equivalent” PDCCH candidate with AL=8.

### Solution 2

The gist of the difference between solution 2 and solution 1 lies in the methods for determining the shift value.

In solution 2, the CCE to REG mapping for the first CORESET may also follow principle #2, i.e., the CCE to REG mapping for the first CORESET may be determined such that a lowest PRB (REG) in a frequency domain of the second CORESET is aligned with a lowest PRB in the frequency domain of a specific CCE. The index of the CCE (i.e., k) may be based on the shift value. For example, the index of the CCE (i.e., k) may be equal to the shift value.

The shift value (e.g., k) in solution 2 may be associated with an ID of a cell on which the UE camps.

In some embodiments of solution 2, the shift value (e.g., k) may be determined based on an association between an ID of a cell on which the UE camps and a CCE in a set of CCEs. The set of CCEs may be associated with one or more cells, each cell of the one or more cells is associated with a CCE in the set of CCEs.

In some examples, the set of CCEs may be configured or pre-configured for the UE or pre-defined (e.g., in a standard). In some examples, the set of CCEs may include CCEs that enable substantively the same PDCCH detection performance.

The following Table 4 provides an example for deriving sets of CCEs include CCEs that enable substantively the same PDCCH detection performance.

TABLE 4

| Index k of | | | |
|---|---|---|---|
| CCE #k of | CCEs contained | | |
| non-punctured | in the punctured | PDCCH candidates | PDCCH candidate |
| CORESET#0 | CORESET#0 | with AL = 4 | with AL = 8 |
| 0 | {0, 2, 4, 6, 8, 10, 1, 3} | {0, 1, 2, 3}, {4, 6}, {8, 10} | {0, 1, 2, 3, 4, 6} |
| 2 | {2, 4, 6, 8, 10, 1, 3, 5} | {1, 2, 3}, {4, 5, 6}, {8, 10} | {1, 2, 3, 4, 5, 6} |
| 4 | {4, 6, 8, 10, 1, 3, 5, 7} | {4, 5, 6, 7}, {8, 10}, {1, 3} | {1, 3, 4, 5, 6, 7} |
| 6 | {6, 8, 10, 1, 3, 5, 7, 9} | {8, 9, 10}, {5, 6, 7}, {1, 3} | {1, 3, 5, 6, 7} |
| 8 | {8, 10, 1, 3, 5, 7, 9, 11} | {8, 9, 10, 11}, {1, 3}, {5, 7} | {1, 3, 5, 7} |
| 10 | {10, 1, 3, 5, 7, 9, 11, 0} | {0, 1, 3}, {9, 10, 11}, {5, 7} | {0, 1, 3, 5, 7} |
| 1 | {1, 3, 5, 7, 9, 11, 0, 2} | {0, 1, 2, 3}, {5, 7}, {9, 11} | {0, 1, 2, 3, 5, 7} |
| 3 | {3, 5, 7, 9, 11, 0, 2, 4} | {0, 2, 3}, {4, 5, 7}, {9, 11} | {0, 2, 3, 4, 5, 7} |
| 5 | {5, 7, 9, 11, 0, 2, 4, 6} | {4, 5, 6, 7}, {9, 11}, {0, 2} | {0, 2, 4, 5, 6, 7} |
| 7 | {7, 9, 11, 0, 2, 4, 6, 8} | {4, 6, 7}, {8, 9, 11}, {0, 2} | {0, 2, 4, 6, 7} |
| 9 | {9, 11, 0, 2, 4, 6, 8, 10} | {8, 9, 10, 11}, {0, 2}, {4, 6} | {0, 2, 4, 6} |
| 11 | {11, 0, 2, 4, 6, 8, 10, 1} | {0, 1, 2}, {8, 10, 11}, {4, 6} | {0, 1, 2, 4, 6} |

Table 4 includes 12 entries. Each entry may include: an index (e.g., k) of a CCE (e.g., CCE #k) included in the non-punctured CORESET#0 (e.g., as shown in FIG. 5A or FIG. 5B), the corresponding CCEs included in the punctured CORESET#0 when principle #2 is satisfied (i.e., a lowest PRB (or REG) in a frequency domain of the punctured CORESET#0 is aligned with a lowest PRB in the frequency domain of the CCE #k), the CCEs in each PDCCH candidate with AL=4 (e.g., by referring to Table 3b), and the CCEs in each PDCCH with AL=8 (e.g., by referring to Table 3b).

Taking CCE #4 as an example, based on the principle that the CCE to REG mapping for CORESET#0 may be determined such that a lowest PRB (REG) in a frequency domain of the second CORESET is aligned with a lowest PRB in the frequency domain of the CCE #4, the CCE to REG mapping for CORESET#0 in FIG. 5A or FIG. 5B may be as follows: CCEs 0, 2, 4, 6, 8, 10 are mapped to REGBs 0, 1, 2, 3, 4, and 5 respectively; and CCEs 1, 3, 5, 7, 9, 11 are mapped to REGBs 6, 7, 8, 9, 10, and 11, respectively. Accordingly, the CCEs included in the punctured CORESET#0 in FIG. 5A or FIG. 5B may be CCEs {4, 6, 8, 10, 1, 3, 5, 7}.

Referring to Table 4, each index of CCE may correspond to a set of PDCCH candidates for an AL. The set of CCEs may include CCEs that enable substantively the same PDCCH detection performance. For example, substantively the same PDCCH detection performance may mean that: the number of CCEs in corresponding PDCCH candidates of two or more sets of PDCCH candidates are the same.

For example, CCE2 (also referred to as CCE #2) correspond to PDCCH candidates including CCEs {1, 2, 3}, {4, 5, 6}, {8, 10} for AL=4 and PDCCH candidate including CCEs {1, 2, 3, 4, 5, 6} for AL=8. CCE3 (also referred to as CCE #3) correspond to PDCCH candidates including CCEs {0, 2, 3}, {4, 5, 7}, {9, 11} for AL=4 and PDCCH candidate including CCEs {0, 2, 3, 4, 5, 7} for AL=8. For AL=4, the numbers of CCEs in the three PDCCH candidates for CCE2 is 3, 3, 2, respectively, which are the same as the numbers of CCEs in the three PDCCH candidates for CCE3. For AL=8, the number of CCEs in the PDCCH candidate for CCE2 is 6, which are the same as the number of CCEs in the PDCCH candidate for CCE3. Accordingly, CCE2 and CCE3 may enable substantively the same PDCCH detection performance and may be included in the same set of CCEs.

Given the above, CCEs 0-11 in Table 4 may be divided into four sets of CCEs (denoted as S1, S2, S3, and S4) as follows:
S1: which includes CCEs {0, 1, 4, 5};
S2: which includes CCEs {2, 3};
S3: which includes CCE {6, 7, 10, 11}; and
S4: which includes CCE {8, 9}.

The actually employed set of CCEs (e.g., one of S1 to S4) may be configured, pre-configured, or pre-defined. After determining the set of CCEs, the UE may determine the shift value (e.g., k) based on an association between an ID of a cell on which the UE camps and a CCE in the set of CCEs.

For example, the association between the ID of the cell and a CCE in the set of CCEs (e.g., denoted as S) may be defined by CCE #k=S (t), where t=the ID of the cell mod m, and m is the number of CCEs in set S. For example, assuming that set S includes 3 CCEs, e.g., S={CCE #b_1, CCE #b_2, CCE #b_3}, then for a cell with ID=1, t=1 mod 3=1, and thus CCE #k=S (1)=CCE #b_1, i.e., the shift value (e.g., k)=b_1.

After determining the shift value (e.g., k), the UE may determine the CCE to REG mapping for the first CORESET based on the value “k” and at least one of PRB offset for the first CORESET or a number of punctured PRBs of a punctured SSB, wherein the PRB offset for the first CORESET and the number of punctured PRBs of a punctured SSB may have the same definitions as those in solution 1. The CCE to REG mapping for the first CORESET may follow principle #2, i.e., the CCE to REG mapping for the first CORESET may be determined such that a lowest PRB (REG) in a frequency domain of the second CORESET is aligned with a lowest PRB in the frequency domain of the CCE #k.

For example, based on the shift value (e.g., k) and at least one of PRB offset for the first CORESET or a number of punctured PRBs of a punctured SSB, the UE may determine n_{shift} in formula (1). Then, the UE may determine the CCE to REG mapping for the first CORESET based on the determined n_{shift} and formula (1) (or principle #1).

Thus, according various methods as described above, the UE can determine a set of CCEs in the second CORESET from the first CORESET based on the mapping. For example, referring to FIG. 5A, as stated above, the first CORESET may be CORESET#0 which includes 24 PRBs in the frequency domain and 3 symbols in the time domain. Since the channel BW only includes 16 RBs, 8 PRBs (i.e., 8 REGs) may be punctured from CORESET#0. That is, REGs 0, 1, 10, and 11 may be punctured from CORESET#0, and thus the second CORESET may be a punctured CORESET#0 including REGs 2-9, which are mapped to CCEs {0, 2, 4, 6, 8, 10, 1, 3} of non-punctured CORESET#0. That is, the punctured CORESET#0 may include CCEs {0, 2, 4, 6, 8, 10, 1, 3} of non-punctured CORESET#0.

The UE may determine a PDCCH candidate including one or more CCEs within the set of CCEs based on an aggregation level. For example, still referring to FIG. 5A, based on Table 3b, for AL=4, the 1^{st}, 2^{nd}, and 3^{rd} PDCCH candidates of the punctured CORESET#0 include CCEs {0, 1, 2, 3}, {4, 6}, and {8, 10}, respectively.

In some embodiments, the UE may perform a PDCCH detection in the one or more CCEs of the PDCCH candidate.

In some embodiments, the UE may perform a PDCCH detection in the one or more CCEs of the PDCCH candidate in the case that the number of CCEs included in the PDCCH candidate is equal to a value within a set of values. In some examples, the set of values may be configured or pre-configured for the UE or pre-defined. For example, the set of values may include 4, 8 or both. Otherwise, the UE may not perform a PDCCH detection in the one or more CCEs of the PDCCH candidate. In other words, the UE may determine that the PDCCH candidate is invalid for PDCCH transmission

In some embodiments, the UE may determine that the PDCCH candidate is invalid for PDCCH transmission in the case that a number of CCEs in the PDCCH candidate is smaller than a threshold. That is, the UE may not perform a PDCCH detection in the one or more CCEs of the PDCCH candidate in the case that a number of CCEs in the PDCCH candidate is smaller than a threshold. In some examples, the threshold may be configured or pre-configured for the UE or pre-defined. For example, the threshold may be equal to the AL. Still referring to FIG. 5A, for AL=4, the 1^{st}, 2^{nd}, and 3^{rd} PDCCH candidates of the punctured CORESET#0 include CCEs {0, 1, 2, 3}, {4, 6}, and {8, 10}, respectively. Assuming that the threshold is 4, then the UE may not perform a PDCCH detection in the 2nd and 3rd PDCCH candidates, i.e., CCEs {4, 6} and CCEs {8, 10}.

According to some embodiments of the present disclosure, the method in FIG. 4 may be performed by a BS (e.g., BS 102 in FIG. 1).

When the method in FIG. 4 is performed by a BS, in step 401, the BS may determine a first CORESET. All the definitions and designs related to the first CORESET as described above may also apply here. Thus, details are omitted for simplicity. It is contemplated that the operations of the BS for determining the first CORESET may be similar to those performed by the UE in step 401. Thus, details are omitted for simplicity.

In some embodiments, the BS may determine a second CORESET by puncturing a set of resources in the first CORESET. All the definitions and designs related to the second CORESET as described above may also apply here. Thus, details are omitted for simplicity. It is contemplated that the operations of the BS for determining the second CORESET may be similar to those performed by the UE. Thus, details are omitted for simplicity.

In step 403, the BS may determine CCE to REG mapping for the first CORESET based on at least one of the followings: a PRB offset for the first CORESET; a number of punctured PRBs of a punctured SSB; or a shift value. Determining CCE to REG mapping for the first CORESET may also be seen as determining the CCE to REG mapping for the second CORESET. It is contemplated that the operations of the BS for determining the CCE to REG mapping for the first CORESET may be similar to those performed by the UE. Thus, details are omitted for simplicity.

In some embodiments of the present disclosure, the BS may determine a set of CCEs in the second CORESET from the first CORESET based on the mapping. It is contemplated that the operations of the BS for determining a set of CCEs in the second CORESET may be similar to those performed by the UE. For example, referring to FIG. 5A, the BS may determine that the punctured CORESET#0 includes CCEs {0, 2, 4, 6, 8, 10, 1, 3} of non-punctured CORESET#0.

The BS may determine a PDCCH candidate including one or more CCEs within the set of CCEs based on an aggregation level. It is contemplated that the operations of the BS for determining a PDCCH candidate may be similar to those performed by the UE. For example, still referring to FIG. 5A, based on Table 3b, for AL=4, the BS may determine that the 1^{st}, 2^{nd}, and 3^{rd} PDCCH candidates of the punctured CORESET#0 includes CCE {0, 1, 2, 3}, {4, 6}, and {8, 10}, respectively.

In some embodiments, the BS may transmit a PDCCH in the one or more CCEs of the PDCCH candidate.

In some embodiments, the BS may transmit a PDCCH in the one or more CCEs of the PDCCH candidate in the case that the number of CCEs included in the PDCCH candidate is equal to a value within a set of values. In some examples, the set of values may be pre-defined. In some examples, the set of values may be determined by the BS and configured or pre-configured for the UE by the BS. For example, the set of values may include 4, 8 or both. Otherwise, the BS may not transmit a PDCCH in the one or more CCEs of the PDCCH candidate. In other words, the BS may determine that the PDCCH candidate is invalid for PDCCH transmission

In some embodiments, the BS may determine that the PDCCH candidate is invalid for PDCCH transmission in the case that a number of CCEs in the PDCCH candidate is smaller than a threshold. That is, the BS may not transmit a PDCCH in the one or more CCEs of the PDCCH candidate in the case that a number of CCEs in the PDCCH candidate is smaller than a threshold. In some examples, the threshold may be pre-defined. In some examples, the threshold may be determined by the BS and configured or pre-configured for the UE by the BS. For example, the threshold may be equal to the AL. Still referring to FIG. 5A, for AL=4, the 1st, 2nd, and 3rd PDCCH candidates of the punctured CORESET#0 include CCEs {0, 1, 2, 3}, {4, 6}, and {8, 10}, respectively. Assuming that the threshold is 4, then the BS may not transmit a PDCCH in the 2nd and 3rd PDCCH candidates, i.e., CCEs {4, 6} and CCEs {8, 10}.

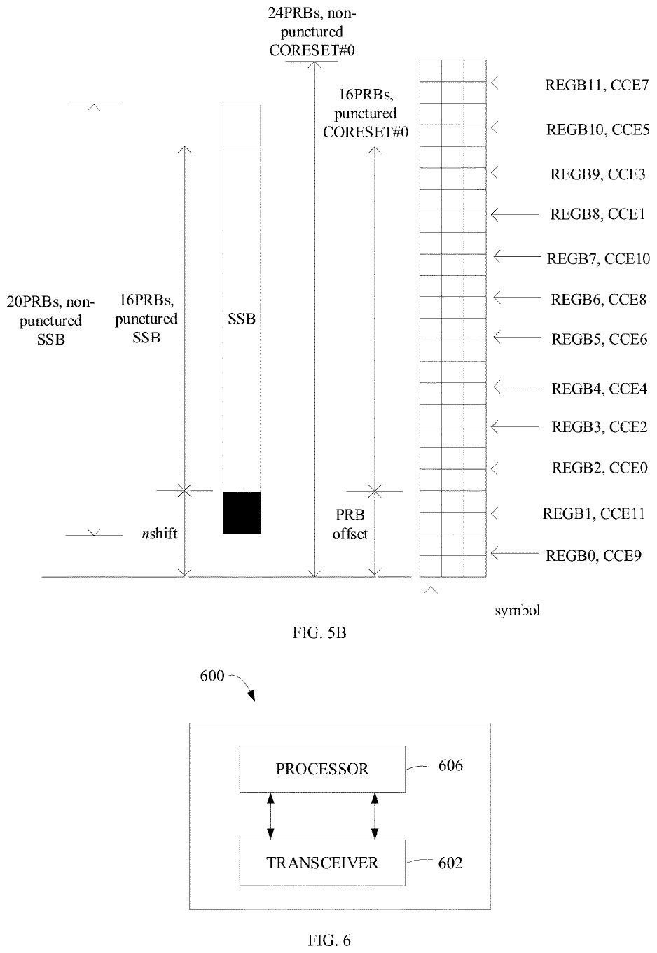

FIG. 6 illustrates a simplified block diagram of an exemplary apparatus according to some embodiments of the present disclosure. As shown in FIG. 6, the apparatus 600 may include at least one processor 606 and at least one transceiver 602 coupled to the processor 606. The apparatus 600 may be a UE or a BS.

Although in this figure, elements such as the at least one transceiver 602 and processor 606 are described in the singular, the plural is contemplated unless a limitation to the singular is explicitly stated. In some embodiments of the present disclosure, the transceiver 602 may be divided into two devices, such as a receiving circuitry and a transmitting circuitry. In some embodiments of the present disclosure, the apparatus 600 may further include an input device, a memory, and/or other components.

In some embodiments of the present disclosure, the apparatus 600 may be a UE. The transceiver 602 and the processor 606 may interact with each other so as to perform the operations with respect to the UE described in FIGS. 1-5B. In some embodiments of the present disclosure, the apparatus 600 may be a BS. The transceiver 602 and the processor 606 may interact with each other so as to perform the operations with respect to the BS described in FIGS. 1-5B.

In some embodiments of the present disclosure, the apparatus 600 may further include at least one non-transitory computer-readable medium.

For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602 to perform the operations with respect to the UE described in FIGS. 1-5B.

In some embodiments of the present disclosure, the non-transitory computer-readable medium may have stored thereon computer-executable instructions to cause the processor 606 to implement the method with respect to the BS as described above. For example, the computer-executable instructions, when executed, cause the processor 606 interacting with transceiver 602 to perform the operations with respect to the BS described in FIGS. 1-5B.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE), comprising:
at least one memory; and
at least one processor coupled with the at least one memory and configured to cause the UE to:
determine a first control resource set (CORESET); and
determine control resource element (CCE) to resource element group (REG) mapping for the first CORESET based on at least one of the following:
a physical resource block (PRB) offset for the first CORESET;
a number of punctured PRBs of a punctured synchronization signal block (SSB); or
a shift value.

2. The UE of claim 1, wherein the at least one processor is configured to cause the UE to determine a second CORESET by puncturing a set of resources in the first CORESET, and wherein a lowest PRB in a frequency domain of the second CORESET is aligned with a lowest PRB in the frequency domain of a CCE, wherein an index of the CCE is based on the shift value.

3. The UE of claim 1, wherein the first CORESET is configured based on the PRB offset, and wherein:
the PRB offset indicates the number of PRBs between a lowest PRB in a frequency domain of the first CORESET and a lowest PRB in the frequency domain of a non-punctured SSB; or
the PRB offset indicates the number of PRBs between a lowest PRB in the frequency domain of the first CORESET and a lowest PRB in the frequency domain of the punctured SSB.

4. The UE of claim 2, wherein the CCE is a CCE included in the first CORESET and the shift value is independent of an identity (ID) of a cell on which the UE camps.

5. The UE of claim 1, wherein the shift value is determined such that it enables a best physical downlink control channel (PDCCH) multiplexing capacity for an aggregation level.

6. The UE of claim 2, wherein the CCE is a CCE indexed with 0, 8, or 9 in the first CORESET.

7. The UE of claim 1, wherein the shift value is determined based on an association between an identity (ID) of a cell on which the UE camps and a CCE in a set of CCEs.

8. The UE of claim 7, wherein the set of CCEs comprises CCEs that enable substantively the same physical downlink control channel (PDCCH) detection performance.

9. The UE of claim 1, wherein the at least one processor is configured to cause the UE to:
determine a set of control channel elements (CCEs) in a second CORESET from the first CORESET based on the mapping; and
determine a physical downlink control channel (PDCCH) candidate including one or more CCEs within the set of CCEs based on an aggregation level.

10. The UE of claim 9, wherein the at least one processor is configured to cause the UE to perform at least one of the following:
performing a PDCCH detection in the one or more CCEs of the PDCCH candidate;
performing a PDCCH detection in the one or more CCEs of the PDCCH candidate in response to the number of CCEs included in the PDCCH candidate being equal to a value within a set of values; or
determining that the PDCCH candidate is invalid for PDCCH transmission in response to a number of CCEs in the PDCCH candidate being smaller than a threshold.

11. The UE of claim 10, wherein the set of values includes 4, 8, or both.

12. A base station, comprising:
at least one memory; and
at least one processor coupled with the at least one memory and configured to cause the base station to:
determine a first control resource set (CORESET); and
determine control resource element (CCE) to resource element group (REG) mapping for the first CORESET based on at least one of the following:
a physical resource block (PRB) offset for the first CORESET,
a number of punctured PRBs of a punctured synchronization signal block (SSB), or
a shift value.

13. The base station of claim 12, wherein the at least one processor is configured to cause the base station to:
determine a set of control channel elements (CCEs) in a second CORESET from the first CORESET based on the mapping; and
determine a physical downlink control channel (PDCCH) candidate including one or more CCEs within the set of CCEs based on an aggregation level.

14. The base station of claim 13, wherein the at least one processor is configured to cause the base station to perform at least one of the following:
transmitting a PDCCH in the one or more CCEs of the PDCCH candidate;
transmitting a PDCCH in the one or more CCEs of the PDCCH candidate in response to the number of CCEs included in the PDCCH candidate being equal to a value within a set of values; or
determining that the PDCCH candidate is invalid for PDCCH transmission in response to a number of CCEs in the PDCCH candidate being smaller than a threshold.

15. A method performed by a user equipment (UE), the method comprising:
determining a first control resource set (CORESET); and
determining control resource element (CCE) to resource element group (REG) mapping for the first CORESET based on at least one of the following:
a physical resource block (PRB) offset for the first CORESET;
a number of punctured PRBs of a punctured synchronization signal block (SSB); or
a shift value.

16. A processor for wireless communication, comprising:
at least one controller coupled with at least one memory and configured to cause the processor to:
determine a first control resource set (CORESET); and
determine control resource element (CCE) to resource element group (REG) mapping for the first CORESET based on at least one of the following:
a physical resource block (PRB) offset for the first CORESET;
a number of punctured PRBs of a punctured synchronization signal block (SSB); or
a shift value.

17. The processor of claim 16, wherein the at least one controller is configured to cause the processor to determine a second CORESET by puncturing a set of resources in the first CORESET, and wherein a lowest PRB in a frequency domain of the second CORESET is aligned with a lowest PRB in the frequency domain of a CCE, wherein an index of the CCE is based on the shift value.

18. The processor of claim 16, wherein the first CORESET is configured based on the PRB offset, and wherein:
the PRB offset indicates the number of PRBs between a lowest PRB in a frequency domain of the first CORESET and a lowest PRB in the frequency domain of a non-punctured SSB; or
the PRB offset indicates the number of PRBs between a lowest PRB in the frequency domain of the first CORESET and a lowest PRB in the frequency domain of the punctured SSB.

19. The processor of claim 17, wherein the CCE is a CCE included in the first CORESET and the shift value is independent of an identity (ID) of a cell on which the UE camps.

20. The processor of claim 16, wherein the shift value is determined such that it enables a best physical downlink control channel (PDCCH) multiplexing capacity for an aggregation level.
